(19) United States
(12) Patent Application Publication
(10) Pub. No.: US 2014/0265608 A1
(43) Pub. Date: Sep. 18, 2014

(54) SYSTEM FOR PRODUCING AND DISTRIBUTING ELECTRICAL ENERGY OVER AN ELECTRICAL GRID, AND ASSOCIATED OPTIMIZATION METHOD

(71) Applicants: Jonathan Roberts, Orsay (FR); Xavier Augustin, Nanterre (FR); Jean-Claude Dellinger, Sainte Foy Les Lyon (FR)

(72) Inventors: Jonathan Roberts, Orsay (FR); Xavier Augustin, Nanterre (FR); Jean-Claude Dellinger, Sainte Foy Les Lyon (FR)

(73) Assignee: SOCIETE TECHNIQUE POUR L'ENERGIE ATOMIQUE TECHNICATOME, Villiers le Bacle (FR)

(21) Appl. No.: 14/235,310

(22) PCT Filed: Jul. 26, 2012
(86) PCT No.: PCT/EP2012/064658

§ 371 Date: May 30, 2014

(30) Foreign Application Priority Data
Jul. 28, 2011 (FR) 1156920

(51) Int. Cl. H02J 3/00

(52) U.S. Cl. CPC H02J 3/00
USPC 307/84

(57) ABSTRACT

A system for producing and distributing electrical energy over an electrical network of a geographic area, includes a first entity for generating electrical energy, which operates in a steady state and generates at least a portion of the electrical energy; a second entity for intermittently generating the electrical energy from renewable energy; a third entity, which is capable of operating in a load-following state, the system being sized such that the profile of the change in total energy potential of the geographic area over the span of one year, corresponding to the sum of the profile of the change in the amount of electrical energy distributed by the main entity and the profile of the change in the amount of electrical energy generated by the second entity over the span of one year, is less than the profile of the change in the demand for electrical energy of the network.

The present invention relates to an electrical energy generating system (comprising an important part of intermittent renewable energies distributed over an electrical grid as well as a method for optimizing and sizing said system in its entirety in order to eliminate recourse to the use of energy storage means to offset the intermittent character of renewable energies.

In order to respond to intra-day variations of electricity demand and to maintain a balance between electrical energy generation and demand, specific generating entities have been developed and designed to adjust their production and thereby supply electrical energy on demand, in other words said specific entities are designed to work in load following state. Said specific generating entities are for example hydroelectric power plants, coal fired or gas fired thermal power plants, etc.

Said specific entities act as a complement to mass production entities which are power plants designed to produce large amounts of energy at the lowest price and enable the supply of the greatest portion of the electrical energy distributed on a grid. They are generally nuclear power plants or fossil fuel power plants that supply so-called base-load electricity.

Finally, a last category of power plant makes it possible to meet consumption peaks. The peaks observed are of two types and may be combined: the daily peak, which is generally situated in the early evening and which is mainly linked to the behaviour of households, and the seasonal peak, which is linked to the climatic conditions of the moment.

In the particular case of France, nuclear power plants, generating base-load electricity, also participate in the operation in a load-following state without having been initially designed for this, consequently leading to premature wear of the installations (wear of fuels, wear of actuators, etc.). This premature wear thus does not make it possible to have an optimum profitability of these nuclear power plants.

The desire to reduce emissions of greenhouse gases is behind the development and the use of renewable energies as main sources of electricity of a grid or instead as secondary sources in completing a main source. Among the different renewable energies, the generation of electricity from solar, wind and sea energy are today the three most promising energy sources and for which technological developments are important.

However, these renewable energy sources are intermittent, random and volatile sources. In addition, the generation of electricity is not necessarily in phase with the demand of the grid, whether temporally or quantitatively. Thus, development of the use of these renewable energies is slowed down in particular by the difficulty of maintaining in real time the balance between electricity generation and consumption.

In order to resolve this problem, extensive research and numerous developments are underway in order to be capable of storing the surplus energy generated by these renewable energies so as to be capable of restoring it in generation shortfall periods. The possibility of storing this energy thus makes it possible to be capable of restoring it on the electrical grid as a function of need and generation.

Conversely, the technical difficulties for achieving storage of the generation of renewable energies are numerous and the technical solutions developed are not yet viable or exploitable at a large scale, with the notable exception of plants for the transfer of energy by pumping (reversible hydroelectric power plants).

To overcome the intermittent, volatile and random nature of the electrical energy generated by renewable energy sources, the document U.S. Pat. No. 6,671,585 describes an example of system for generating energy, a method and a computer programme capable of improving the commercial value of the electrical energy coming from an installation using renewable energy. The system for generating energy described is formed by the combination of at least three electrical generators, such as a nuclear power plant, a hydro-electric power plant, a gas fired power plant as well as a renewable energy source. More precisely, the system for generating energy described comprises an electric generator capable of operating at constant state, a source of renewable energy generating electrical energy in a variable manner and a third electrical generator managed on-line in order that its energy production is adjusted so as to maintain the balance of the electrical grid as a function of the amount of energy generated by the renewable energy source (wind energy). The greater or lesser amount of energy generated by the electrical generator managed on-line, compared to its forecast, is counted and registered in a stored virtual energy account. In the case of under-production of electricity of renewable origin, the managed power plant compensates and debits the account of the wind turbine. Conversely, the account is credited in the case of a surplus of generating electricity of renewable origin compared to demand.

Such a system makes it possible to offset the particular behaviour of certain renewable energy sources—one end of the energy chain—without however protecting against the accelerated wear of mass generating entities that continue to operate in load-following state, the latter having for origin the energy demand that lies at the other end of the energy chain.

In this context, the invention aims to propose a system for generating and distributing electrical energy over a grid enabling the aforementioned problems to be resolved.

To this end, the invention proposes a system for generating and distributing electrical energy over an electrical grid defined by a given geographic area characterised in that it comprises:
a main entity for generating electrical energy which operates in a steady state and generates at least a portion of the electrical energy generated on said grid;
a second entity for generating electrical energy from renewable energy, not associated with energy storage means, which intermittently generates the electrical energy generated on said grid;
a third entity for generating electrical energy capable of operating in a load-following state and capable of supplying the energy generated on said grid;
   said system being sized so that the profile of the change in total energy potential over the span of one year of said geographic area, corresponding to the sum of the profile of the change in the amount of electrical energy distributed over the span of one year by said main entity for generating electrical energy and the profile of the change in the amount of electrical energy generated over the span of one year by said second entity for generating electrical energy from renewable energy, is less than the profile of the change in the demand for electrical energy over the span of one year of said grid defined by said given geographic area.

The term “renewable energy” is taken to mean the forms of energy which renew themselves quickly enough to be considered as inexhaustible on a human scale. Thus, as an example, solar energy, wind energy, wave energy, hydrokinetic energy are forms of renewable energy.

The term “generating entity” is taken to mean not just a single module for generating but also a series of modules for generating electrical energy.

The generating and distributing system according to the invention thus makes it possible to become free of the constraints of storage of the excess of generating renewable energy in periods of over-production compared to the demand of the grid (energy that is re-injected into the grid when demand is greater than production).

In addition, fluctuations in demand of the grid are made good by a third complementary generating entity intended and sized so as to take complete responsibility for load-following, thereby enabling direct and favoured distribution on the electrical grid of the electricity generated by renewable energies on the grid.

Thanks to the invention, the use of entities for generating electrical energy (advantageously of low power) dedicated and designed with the aim of operating in load-following state makes it possible to design and operate mass generating entities in steady state. Thus, the economic and energy efficiency of these mass generating entities is improved by operation at a nominal power. These mass generating entities no longer participate in load-following, their lifetime is extended and the operating costs are reduced.

The sizing and the operation of installations for generating electricity are thereby optimized.

Furthermore, the third generating entities capable of operating in a load-following state are advantageously located geographically as near as possible to consumption areas in order to optimize the logistics system for generating and distributing electrical energy.

The third entities for generating electrical energy capable of operating in a load-following state are advantageously formed of one or more mass-produced power modules.

The system according to the invention also makes it possible to become free of the use of back-up generating entities supplied with fossil resources and polluting generating entities subjected to discharge standards. Thus, the system according to the invention makes it possible to reduce polluting emissions by the reduction or even the elimination of the use of these types of entities.

Thanks to the invention, renewable energies are valorised in an optimal manner since their random, intermittent and volatile nature is no longer a drawback. Thus, the system according to the invention makes it possible to participate in the commercial development of these technologies.

The system for generating and distributing electrical energy over a grid according to the invention may also have one or more of the following characteristics, considered individually or according to any technically possible combinations thereof:
said main entity for generating energy distributes at least 50% of the electrical energy required to meet the demand of said grid;
said first entity for generating and said third entity for generating electrical energy capable of operating in a load-following state are formed of a same generating unit;
said third entity for generating electrical energy is formed of a single module or a plurality of identical power modules;
the power of each of the modules of said third entity for generating electrical energy is comprised between 100 MWe and 500 MWe;
said third entity for generating electrical energy is a small nuclear reactor;
said second entity for generating electrical energy from renewable energy and/or said third entity for generating electrical energy is sited in said given geographic area;
said system is sized such that a management window, defined by the minimum deviation Eₘᵢₙ and the maximum deviation Eₘₐₓ between said profile of the change in the total energy potential generated over the span of one year and said profile of the change in the demand for electrical energy over the span of one year of said grid, is comprised in an optimal generating interval of said third entity for generating electrical energy;
said sizing so that said management window is comprised in the optimal generating interval of said third entity for generating electrical energy is achieved by re-sizing of the power of said third entity for generating electrical energy;
said third entity for generating electrical energy is constituted of at least one power module; said sizing so that said management window is comprised in the optimal generating interval of said third entity for generating electrical energy being achieved by the adjustment of the number of power modules forming said third generating entity over said given geographic area.

The invention also relates to a method for optimizing a system for generating and distributing electrical energy according to the invention comprising the steps consisting in:
estimating over the span of one year a profile of the change in the demand for electrical energy of said grid, defined by said given geographic area;
calculating a profile of the change in the amount of electrical energy distributed over the span of one year by said first entity for generating electrical energy on said grid;
evaluating a profile of the change in the amount of electrical energy produced over the span of one year by said second entity for generating electrical energy from renewable energy and distributed on said grid;
comparing said profile of the change in the total energy potential generated over the span of one year on said geographic area with said profile of the change in the estimated demand for electrical energy, said profile of the change in said total energy potential generated over the span of one year corresponding to the sum of said profile of the change in said amount of electrical energy distributed over the span of one year by said first entity for generating electrical energy and of said profile of the change in the amount of electrical energy generated over the span of one year by said second entity for generating electrical energy from renewable energy;
modifying the extent of said geographic area or the amount of electrical energy distributed on said grid by said main generating entity if said profile of the change in said total annual energy potential of said geographic area is less than the profile of the change in said demand;
determining the minimum deviation Eₘᵢₙ and the maximum deviation Eₘₐₓ between said profile of the change in said total energy potential generated over the span of one year and said profile of the change in said electrical energy demand over the span of one year, said minimum deviation and said maximum deviation forming a management window;
comparing said management window determined during the preceding step with an optimal electrical energy generating interval of said third entity for generating electrical energy capable of operating in a load-following state;
modifying the extent of said geographic area and/or sizing said third generating entity and/or, in the hypothesis where the third generating entity is formed of one or more modules of identical power, adapting the number of power modules forming said third generating entity so that said management window is comprised in the optimal generating interval of said third entity for generating electrical energy.

The invention consists in defining and implementing the method which makes it possible to choose an optimum combination between the different sets of generating entities enabling in particular an optimal valorisation of renewable energies without having recourse to storage installations.

To do so, the third generating entity is sized to respond at any moment to the energy demand not covered by the first and the second generating entity particularly when the generating level of the second entity cannot meet the demand (lack of sunlight, wind, etc.).

Thus, the third generating entity is sized so as to cover the energy needs defined between the profile of the change in the total energy potential generated over the span of one year (curve A of FIG. 2) and the profile of the change in the demand for electrical energy over the span of one year (curve B of FIG. 2).

According to an advantageous embodiment, said optimal generating interval of said third entity for generating electrical energy lies between 40% and 80% of the maximum power of said entity or of each power module forming said third generating entity.

Other characteristics and advantages of the invention will become clearer from the description that is given thereof below, as an indication and in no way limiting, with reference to the appended figures, among which:

FIG. 1 is a schematic representation of a system for generating and distributing electrical energy over a grid according to the invention;

FIG. 2 is a graph illustrating the profile over the span of one year of the distribution of electrical energy demand/generation for a given geographic area.

In all of the figures, common elements bear the same reference numbers unless specified otherwise.

FIG. 1 schematically illustrates a first example of siting of different electrical energy entities enabling a given geographic area to be supplied with electrical energy.

The system for generating and distributing 100 is formed by;
a first so-called main entity for generating electrical energy 110, which operates in a steady state and distributing at least a portion of the electrical energy generated over an electrical grid 200 corresponding to the given geographic area;
a second entity for generating electrical energy from renewable energy 120, directly distributed over the electrical grid 200 and thus not associated with electrical energy storage means, and distributing in an intermittent manner the electrical energy generated on the grid 200;
a third entity for generating electrical energy 130 capable of operating in a load-following state as a function of the demand of the grid 200 and of the amount of electrical energy supplied by said first generating entity 110 and the entity for generating renewable energy 120.

Advantageously, the entity for generating renewable energy 120 generates electricity from solar energy, wind energy or instead sea energy (wave, current, etc.).

Advantageously, the first generating entity 110 is formed of at least one generator power plant sized and optimized to operate in steady state.

Advantageously, the third entity for generating electrical energy 130 is formed of at least one small nuclear reactor, typically of electrical power comprised between 100 and 500 megawatts (MWe).

The generating and distributing system 100 is associated with an optimization method making it possible to dimension and exploit the generating and distributing system in an optimum manner over a given geographic area.

Firstly, it is necessary to define the geographic area capable of receiving the electricity generated by the system.

Thus, for this geographic area, the optimization method according to the invention consists in:
calculating, from historical generating data, the profile of the portion of the generation of electricity of the first mass generating entity 110 distributed over the span of one year over this given geographic area;
estimating by simulations, from natural resources (wind, solar, wave, current, etc.) data and from the characteristics of existing (or envisaged) entities for generating renewable energy supplying said geographic area, the profile of the amount of renewable energy available to the geographic area over the span of one year.

The profile of the amount of electrical energy distributed over the span of one year by the first mass generating entity 110 and the profile of the amount of electrical energy generated over the span of one year by the entities for generating renewable energy 120 define a profile of an energy potential available over the span of one year on said geographic area. The profile of the change in the energy potential of the geographic area is represented in FIG. 2 by curve A.

The optimization method also consists in calculating, from historical consumption data, the profile of the demand of the grid over the span of one year defined by this geographic area. The profile of the change in the energy demand is represented by curve B in FIG. 2.

If the energy demand is at least from time to time less than the energy potential generated by the main entity 110 and by the second renewable energy entity 120 (i.e. curve A intersects curve B), there is then an over-production of energy. Since the method and the system according to the invention consist in becoming free of the storage of generated electrical energy derived from renewable energy, while avoiding losing the energy generated by renewable energy entities, the optimization method comprises a step consisting in redefining the geographic area and/or in re-assigning the electrical energy generated from renewable energy for another geographic area, and/or modifying the amount of energy assigned to the geographic area by the mass generating entity 110, so that curve B (energy demand) is strictly above curve A (generated energy potential) whatever the position on the time scale (FIG. 2).

Secondly, the optimization method according to the invention consists in determining the number of modules and the power of the third generating entity 130 so as to respect an optimal operating interval of this entity.

To do so, the optimization method consists in determining the minimum deviation Eₘᵢₙ and the maximum deviation Eₘₐₓ between the energy demand (curve B) and the available energy potential (curve A). This minimum deviation Eₘᵢₙ and this maximum deviation Eₘₐₓ define a management window that the third entity for generating electrical energy 130 will have to supply in load-monitoring state.

If the limits of this window are below the optimal generating interval of the third generating entity 130, the balance of the grid over the given geographic area is then obtained without energy storage. As an example, the optimal generating interval corresponds to an operation between 40% and 80% of the maximum power of the third generating entity 130. This limit for generating electrical energy determines the operating limits in a load-following state of the third generating entity 130, making it possible in particular to specify the operating window of the small nuclear reactor.

If the upper limit of this window is above the optimal generating interval of the third generating entity 130, then it is necessary to lower the upper limit of this window (i.e. lower the maximum deviation Eₘₐₓ). To do so, it is possible:
either to modify the definition of the geographic area so as to reduce the energy demand (curve B) of the area;
or to modify the optimal operating capacity of the third generating entity, and thus the amount of energy delivered for operation in a load-following state in the optimal generating range.

If the lower limit of this window is below the optimal generating interval of the third generating entity 130, then it is necessary to re-define the geographic area to be considered (i.e. extend it) so as to increase the energy demand of the geographic area.

Thus, the optimization method according to the invention consists in determining the number of modules and/or the power of the third entity for generating energy 130 in order to respect an optimal electrical energy generating interval for which it is designed.

In a first embodiment, the modification of the optimal generating capacity of the third generating entity 130 may be achieved by re-sizing of the third generating entity 130.

In a second embodiment in which the third generating entity 130 is formed of one or more identical power modules, the modification of the generating capacity is achieved by the adjustment of the number of power modules forming the third generating entity 130 in the geographic area.

In this second embodiment, the optimal generating capacity of the third generating entity 130 is thus modified by the addition or the elimination of a module. This second embodiment has the advantage of simplifying the production of this type of entities for generating intended to work in load-following state by the mass production of identical electrical power modules. This second embodiment also makes it possible to reduce the costs for generating such entities.

The determination of the demand/production balance and the sizing of the generating and distributing system may be obtained by software means, computers, by successive iterations on the geographic area considered while verifying that the energy demand of the zone (curve B) is always above the energy potential (curve A) produced by the first entity 110 and by the second renewable energy entity 120.

The system according to the invention has been particularly described with a first mass electrical energy generating entity capable of operating in a load-following state; nevertheless, in a particular embodiment of the invention, the first mass generating entity and the third load-following entity are formed physically of a same generating unit capable of being formed of a single power module or of a plurality of power modules, advantageously identical.

The other advantages of the invention are particularly the following:
improving the attractiveness and economic interest of renewable energies by compensating their major drawback (i.e. their intermittence);
improving the economic and energy efficiency of mass electrical energy generating power plants by their operation at a constant nominal power;
increasing the lifetime of mass generating entities;
eliminating recourse to energy storage (storage of resource or storage of the renewable energy produced):
reducing electricity price volatility by a permanent adaptation, in real time, of the offer compared to the demand including during intermittent variations of the generation of electricity from renewable energies;
reducing polluting emissions (C02, NOx, SOx, particles, etc.) by reducing (or eliminating) recourse to back-up power plants supplied with fossil resources;
optimizing the sizing and the operating of electrical energy generating and distributing grids thanks to the shrewd siting of low power generating entities operating in a load-following state (on land/onshore or at sea/offshore);
optimizing the sizing of installations for generating electrical energy on the basis of the optimal valorisation of renewable energies.

1. System for generating and distributing electrical energy over an electrical grid defined by a geographic area, the system comprising:
a first main entity for generating electrical energy, which operates in a steady state and generates at least a portion of the electrical energy generated on said grid;
a second entity for generating electrical energy from renewable energy, not associated with an energy storage device, which intermittently generates the electrical energy generated on said grid;
a third entity for generating electrical energy capable of operating in a load-following state and capable of supplying the energy generated on said grid;
said system being sized such that the profile of the change in the total energy potential over the span of one year of said geographic area, corresponding to the sum of profile of the change in the amount of electrical energy distributed over the span of one year by said first main entity for generating electrical energy and the profile of the change in the amount of electrical energy generated over the span of one year by said second entity for generating electrical energy from renewable energy, is less than the profile of the change in the demand for electrical energy over the span of one year of said grid defined by said geographic area.

2. System for generating and distributing electrical energy according to the claim 1, wherein said first main entity for generating energy distributes at least 50% of the electrical energy required to meet the demand of said grid.

3. System for generating and distributing electrical energy according to claim 1, wherein said first main entity for generating and said third entity for generating electrical energy capable of operating in a load-following state are formed of a same generating unit.

4. System for generating and distributing electrical energy according to claim 1, wherein said third entity for generating electrical energy is formed of a single module or of a plurality of identical power modules.

5. System for generating and distributing electrical energy according to the claim 4, wherein the power of each of the modules of said third entity for generating electrical energy is comprised between 100 MWe and 500 MWe.

6. System for generating and distributing electrical energy according to claim 1, wherein said third entity for generating electrical energy is a small nuclear reactor.

7. System for generating and distributing electrical energy according to claim 1, wherein said second entity for generating electrical energy from renewable energy and/or said third entity for generating electrical energy is sited in said geographic area.

8. System for generating and distributing electrical energy according to the claim 7, wherein said system is sized such that a management window, defined by the minimum deviation and the maximum deviation between said profile of the change in the total energy potential produced over the span of one year and said profile of the change in the demand for electrical energy over the span of one year of said grid, is comprised in an optimal generating interval of said third entity for generating electrical energy.

9. System for generating and distributing electrical energy according to the claim 8, wherein said sizing so that said management window is comprised in the optimal generating interval of said third entity for generating electrical energy is achieved by re-sizing of the power of said third entity for generating electrical energy.

10. System for generating and distributing electrical energy according to claim 1, wherein said third entity for generating electrical energy is constituted of at least one power module;
said sizing so that said management window is comprised in the optimal generating interval of said third entity for generating electrical energy being achieved by adjustment of the number of power modules forming said third generating entity over said geographic area.

11. Method of optimizing a system for generating and distributing electrical energy according to claim 1, said optimization method comprising:
estimating over the span of one year a profile of the change in the electrical energy demand of said grid, defined by said given geographic area;
calculating a profile of the change in the amount of electrical energy distributed over the span of one year by said first entity for generating electrical energy on said grid;
evaluating a profile of the change in the amount of electrical energy generated over the span of one year by said second entity for generating electrical energy from renewable energy and distributed on said grid;
comparing said profile of the change in the total energy potential generated over the span of one year on said geographic area with said estimated profile of the change in the demand for electrical energy, said profile of the change in said total energy potential generated over the span of one year corresponding to the sum of said profile of the change in said amount of electrical energy distributed over the span of one year by said first entity for generating electrical energy and of said profile of the change in the amount of electrical energy generated over the span of one year by said second entity for generating electrical energy from renewable energy;
modifying the extent of said geographic area or the amount of electrical energy distributed on said grid by said main generating entity if said profile of the change in said total annual energy potential of said geographic area is less than the profile of the change in said demand;
determining the minimum deviation and the maximum deviation between said profile of the change in said total energy potential generated over the span of one year and said profile of the change in said electrical energy demand over the span of one year, said minimum deviation and said maximum deviation forming a management window;
comparing said management window determined during the determining with an optimal electrical energy generating interval of said third entity for generating electrical energy capable of operating in a load-following state;
modifying the extent of said geographic area and/or sizing said third generating entity and/or, in the hypothesis where the third generating entity is formed of one or more identical power modules, adapting the number of power modules forming said third generating entity so that said management window is comprised in the optimal generating interval of said third entity for generating electrical energy.

12. Method for optimizing a system for generating and distributing electrical energy according to the claim 11, wherein said optimal generating interval of said third entity for generating electrical energy lies between 40% and 80% of the maximum power of said entity or of each power module forming said third generating entity.
